(19) United States
(12) Patent Application Publication
(10) Pub. No.: US 2025/0148801 A1
(43) Pub. Date: May 8, 2025

(54) APPARATUS AND METHOD FOR CONTROLLING A VEHICLE

(71) Applicants: HYUNDAI MOTOR COMPANY, Seoul (KR); KIA CORPORATION, Seoul (KR)

(72) Inventor: Jong Hyun Choi, Seoul (KR)

(73) Assignees: HYUNDAI MOTOR COMPANY, Seoul (KR); KIA CORPORATION, Seoul (KR)

(21) Appl. No.: 18/640,426

(22) Filed: Apr. 19, 2024

(30) Foreign Application Priority Data
Nov. 6, 2023 (KR) 10-2023-0151994

(51) Int. Cl. G06V 20/58; B60W 50/00; B60W 60/00; G01S 7/4865; G01S 17/86; G01S 17/89; G01S 17/931; G06T 7/55; G06V 10/75; G06V 10/80

(52) U.S. Cl. CPC G06V 20/58; B60W 50/00; G01S 7/4865; G01S 17/86; G01S 17/89; G01S 17/931; G06T 7/55; G06V 10/751; G06V 10/806; B60W 60/00; B60W 2420/403; B60W 2420/408; G06T 2207/10028; G06T 2207/20081; G06T 2207/30252

(57) ABSTRACT

An apparatus for controlling a vehicle includes a camera configured to obtain a surrounding image of the vehicle and a Lidar configured to obtain point cloud data detected from one or more object positioned around the vehicle. The apparatus also includes a controller configured to generate information about a three dimensional (3D) bounding box and information about a two dimensional (2D) keypoint, corresponding to each object among the one or more objects, based on sensor data obtained from the camera and the Lidar. The controller is further configured to estimate a depth of each keypoint, based on the information about the 3D bounding box and the information about the information about the 2D keypoint, to generate information about a 3D keypoint for each object among the one or more objects.

### CROSS-REFERENCE TO RELATED APPLICATION

This application claims the benefit of and priority to Korean Patent Application No. 10-2023-0151994, filed on Nov. 6, 2023, the entire contents of which are incorporated herein by reference.

### TECHNICAL FIELD

The present disclosure relates to an apparatus and method for controlling a vehicle.

### BACKGROUND

An autonomous driving system of a vehicle uses a technology for exactly identifying a surrounding environment (that is, a surrounding object) of a vehicle. Accordingly, the vehicle may include various sensors, such as a camera, a radar and/or light and ranging (Lidar) device. In addition, a technology for detecting, tracking and/or classifying the surrounding object of the vehicle, based on sensor data acquired through the sensors has been used in the vehicle.

A vehicle employing a conventional autonomous driving system receives a camera image in each direction around the vehicle, estimates the position and the type of surrounding objects through a deep-learning model, and performs an autonomous driving control operation based on the estimation result. In this case, the technology for estimating three-dimensional (3D) information of the object based on the camera image is used to recognize the object in various autonomous driving operations.

However, the technology that estimates the three-dimensional (3D) information of an object based on the camera image has limitations, particularly in situations where fine precision at the centimeter level and accurate pose information of a facing vehicle, such as in a parking situation, is desired. In addition, the technology for estimating the 3D information of the object based on the camera image has a limitation in detecting the pose or the intent of a pedestrian.

Generally, the vehicle employing the autonomous driving system recognizes the object, based on information about a keypoint of the object obtained from the sensor, and performs an autonomous driving control operation based on the object. As described above, the technology for recognizing the object (e.g., a pedestrian or another vehicle) based on the information about the keypoint of the object may estimate the precise pose and the precise shape of a pedestrian or another vehicle positioned near the vehicle.

However, in general, the information (keypoint information) about the keypoint is two dimensional (2D) information. Accordingly, it is difficult to estimate the motion of the object in real space. In addition, when the pose of an object or a portion of the object is hidden by another object, the object is erroneously recognized as a different object, i.e., the accuracy in recognizing the object is degraded. Accordingly, the autonomous driving system is limitedly utilized.

### SUMMARY

The present disclosure has been made to solve the above-mentioned problems occurring in the prior art while advantages achieved by the prior art are maintained intact.

An aspect of the present disclosure provides an apparatus and method for controlling a vehicle, capable of generating information about a 3D keypoint in a 3D space, based on information about a 3D bounding box corresponding to an object and information about a 2D keypoint corresponding to the object, such that the pose and the motion of the object are easily detected, based on the information about the 3D keypoint.

Another aspect of the present disclosure provides an apparatus and method for controlling a vehicle, capable of estimating the depth and a hidden point of a 3D keypoint when information about the 3D keypoint of the object is generated, thereby precisely detecting the information about the object, and increasing object recognition rate, allowing for the information about the object to be utilized.

Another aspect of the present disclosure provides an apparatus and method for controlling a vehicle, capable of easily detecting the pose of a pedestrian and/or the intent of the pedestrian, based on information about a 3D keypoint obtained for the pedestrian.

The technical problems to be solved by the present disclosure are not limited to the aforementioned problems, and other technical problems not mentioned herein should be more clearly understood from the following description by those having ordinary skill in the art to which the present disclosure pertains.

According to an aspect of the present disclosure, an apparatus for controlling a vehicle is provided. The apparatus may include a camera configured to obtain a surrounding image of the vehicle, and a Lidar configured to obtain point cloud data detected from one or more objects positioned around the vehicle. The apparatus also includes a controller configured to generate information about a three dimensional (3D) bounding box and information about a two dimensional (2D) keypoint, corresponding to the one or more objects, based on sensor data obtained from the camera and the Lidar. The controller is also configured to estimate a depth of each keypoints, based on the information about the 3D bounding box and the information about the information about the 2D keypoint, to generate information about a 3D keypoint for each object among the one or more objects. The controller is additionally configured to recognize each object, among the one or more objects, based on the information about the 3D bounding box and the information about the 3D keypoint.

According to an embodiment, the controller may be configured to, when generating the information about the 3D keypoint for the each object among the one or more objects, match a bounding box for the each object with a keypoint cluster. The controller may also be configured to select Lidar points, among Lidar points obtained from the Lidar, that are positioned inside each bounding box. The controller may further be configured to project the selected Lidar points onto an image obtained from the camera.

According to an embodiment, the controller may be configured to, when generating the information about the 3D keypoint for each object among the one or more objects, calculate a keypoint weight using the selected Lidar points and information about keypoints matched to the bounding box. The controller may further be configured to calculate depths of the keypoints by applying the keypoint weight to depths of the Lidar points.

According to an embodiment, the keypoint weight may be calculated by using an exponential function having distances between the Lidar points and the keypoints matched with the bounding box, as exponents.

According to an embodiment, the controller may be configured to, when generating the information about the 3D keypoint for the each object among the one or more objects, calculate reliability for the depths of the keypoints which are calculated based on a distribution state of the Lidar points for a surrounding region of the keypoint.

According to an embodiment, the controller may be configured to, when generating the information about the 3D keypoint for the each object among the one or more objects, calculate the reliability for the depths of the keypoints by using distances between the Lidar points and the keypoints matched with the bounding box and a mean value and a standard deviation of the distances.

According to an embodiment, the reliability for the depths of the keypoints may have a greater value as compared to the Lidar points.

According to an embodiment, the controller may be configured to, when generating the information about the 3D keypoint for the each object among the one or more objects, generate pseudo keypoint coordinates based on coordinates and depth values of the keypoints. The controller may also be configured to project the generated pseudo keypoint coordinates onto a Lidar space.

According to an embodiment, the controller may be configured to, when generating the information about the 3D keypoint for the each object among the one or more objects, allow pseudo keypoint coordinates, that are projected onto the Lidar space, to be bilaterally symmetrical to each other about a center of the bounding box of the each object, in a cross-sectional view. The controller may also be configured to prevent keypoint coordinates, among the pseudo keypoint coordinates that are projected onto the Lidar space, that are equal to or less than a reference value in the reliability for the depths of the keypoints from being bilaterally symmetrical to each other.

According to an embodiment, the controller may be configured to, when i) the pseudo keypoint coordinates are projected onto the Lidar space and ii) keypoint coordinates are present at a relevant position in the Lidar space, compare in reliability between the depths of the keypoint and the pseudo keypoint, and select a keypoint having higher reliability.

According to an embodiment, the controller may be further configured to remove, from the Lidar space, keypoint coordinates, among keypoint coordinates projected onto the Lidar space. The controller may also be configured to correct reliability of relevant the keypoint coordinates to zero, if the pseudo keypoint coordinates are projected onto the Lidar space.

According to an embodiment, the controller may be configured to learn an operation for generating the information about the 3D bounding box corresponding to the one or more objects and the information about the 3D keypoint corresponding to the at least one object, based on the sensor data obtained from the camera and the Lidar. The controller may further be configured to output learning data generated as a learning result.

According to an embodiment, the controller may be configured to learn information about the 3D keypoint when reliability for a depth of the 3D keypoint exceeds a reference value.

According to an embodiment, the controller may be configured to, when learning the information about the 3D keypoint, calculate loss of the depth of the 3D keypoint depth by employing the reliability for the depth of the 3D keypoint as a weight. The controller may also be configured to, when estimating the 3D keypoint based on learning data, reflect the loss of the depth of the 3D keypoint.

According to another aspect of the present disclosure, a method for controlling a vehicle is provided. The method includes generating information about a 3D bounding box and information about a 2D keypoint, corresponding to one object or more objects positioned around the vehicle, based on sensor data obtained from a camera and a Lidar. The method also includes estimating a depth of each keypoints, based on the information about the 3D bounding box and the information about the information about the 2D keypoint, to generate information about a 3D keypoint for each object among the one or more objects. The method further includes recognizing each object, among the one or more objects, based on the information about the 3D bounding box and the information about the 3D keypoint.

According to an embodiment, generating the information about the 3D keypoint for each object among the one or more objects may include matching a bounding box for the each object with a keypoint cluster. Generating the information about the 3D keypoint for the each object may also include selecting Lidar points, that are positioned in each bounding box, among Lidar points obtained from the Lidar. Generating the information about the 3D keypoint for the each object may further include projecting the selected Lidar points onto an image obtained from the camera. Generating the information about the 3D keypoint for the each object may additionally include calculating a keypoint weight using the selected Lidar points and information about keypoints matched to the bounding box. Generating the information about the 3D keypoint for the each object may further include calculating depths of the keypoints by applying the keypoint weight to depths of the Lidar points. Generating the information about the 3D keypoint for the each object may additionally include calculating reliability for the depths of the keypoints based on distribution state of the Lidar points for a surrounding region of the keypoint, Generating the information about the 3D keypoint for the each object may further include generating pseudo keypoint coordinates based on coordinates and depth values of the keypoints, and projecting the generated pseudo keypoint coordinates onto a Lidar space.

According to an embodiment, generating the information about the 3D keypoint for each object among the one or more objects may comprise allowing pseudo keypoint coordinates, which are projected onto the Lidar space, to be bilaterally symmetrical to each other about a center of the bounding box of the each object, in a cross-sectional view. Generating the information about the 3D keypoint for the each object may also include keypoint coordinates, among the pseudo keypoint preventing coordinates that are projected onto the Lidar space, that are equal to or less than a reference value in the reliability for the depths of the keypoints, from being bilaterally symmetrical to each other.

According to an embodiment, generating the information about the 3D keypoint for each object may include, when the pseudo keypoint coordinates are projected onto the Lidar space, and if keypoint coordinates are present at a relevant position in the Lidar space, comparing reliability between the depths of the keypoint and the pseudo keypoint, and selecting a keypoint having higher reliability.

According to an embodiment, generating the information about the 3D keypoint for each object among the one or more objects may include removing, from the Lidar space, keypoint coordinates, among keypoint coordinates projected onto the Lidar space, that are outside of the bounding box of the each object, and correcting reliability for relevant keypoint coordinates to zero, when the pseudo keypoint coordinates are projected onto the Lidar space.

According to an embodiment, the method may further include learning an operation for generating the information about the 3D bounding box corresponding to the at least one object and the information about the 3D keypoint corresponding to the one or more objects, based on the sensor data obtained from the camera and the Lidar. The methods may additionally include outputting learning data generated as a learning result.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a view illustrating the configuration of an apparatus for controlling a vehicle, according to an embodiment of the present disclosure;

FIGS. 2A and 2B are views illustrating an operation for generating 3D keypoint data by a vehicle control apparatus, according to an embodiment of the present disclosure;

FIG. 3 is a view illustrating a control structure of a controller, according to an embodiment of the present disclosure;

FIG. 4 is a view illustrating an operation for recognizing an object based on learning data of a vehicle control apparatus, according to an embodiment of the present disclosure;

FIGS. 5-7 are flowcharts of a method for controlling a vehicle, according to an embodiment of the present disclosure;

and

FIG. 8 is a view illustrating a computing system, according to one embodiment of the present disclosure.

### DETAILED DESCRIPTION

Hereinafter, embodiments of the present disclosure are described in detail with reference to accompanying drawings. In the accompanying drawings, the identical or equivalent components are designated by the identical or equivalent numerals even when the components are illustrated in different drawings. Further, in the following description, where it has been considered that a detailed specific description of well-known features or functions may unnecessarily obscure the gist of the present disclosure, a detailed description thereof has been omitted.

In addition, in the following description of components according to an embodiment of the present disclosure, the terms ‘first’, ‘second’, ‘A’, ‘B’, ‘(a)’, and ‘(b)’ may be used. These terms are only used to distinguish one element from another element, but do not limit the corresponding elements irrespective of the order or priority of the corresponding elements. In addition, unless otherwise defined, all terms used herein, including technical or scientific terms, have the same meanings as those generally understood by those having ordinary skill in the art to which the present disclosure pertains. Such terms as those defined in a generally used dictionary should be interpreted as having meanings to the same as the contextual meanings in the relevant field of art, and are not to be interpreted as having ideal or excessively formal meanings unless clearly defined as having such in the present application.

When a component, device, element, or the like of the present disclosure is described as having a purpose or performing an operation, function, or the like, the component, device, or element should be considered herein as being “configured to” meet that purpose or perform that operation or function.

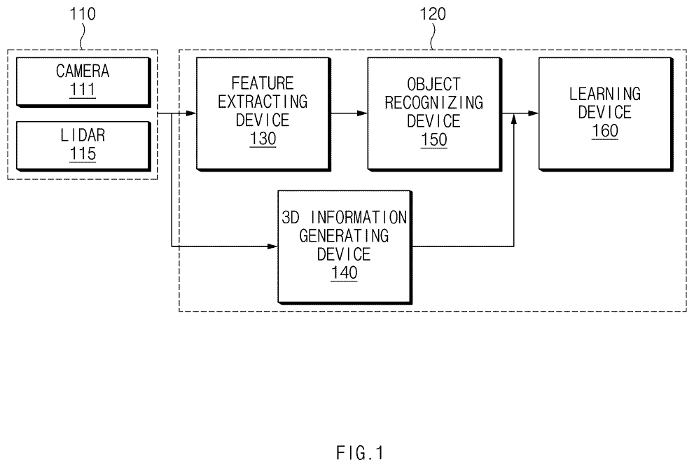

Hereinafter, embodiments of the present disclosure are described with reference to FIGS. 1-8.

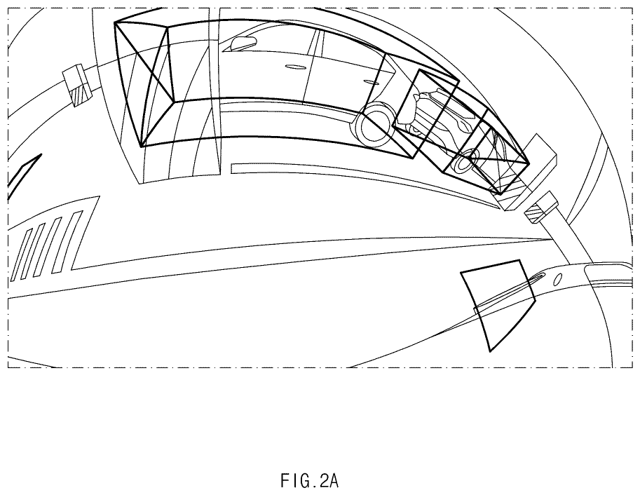

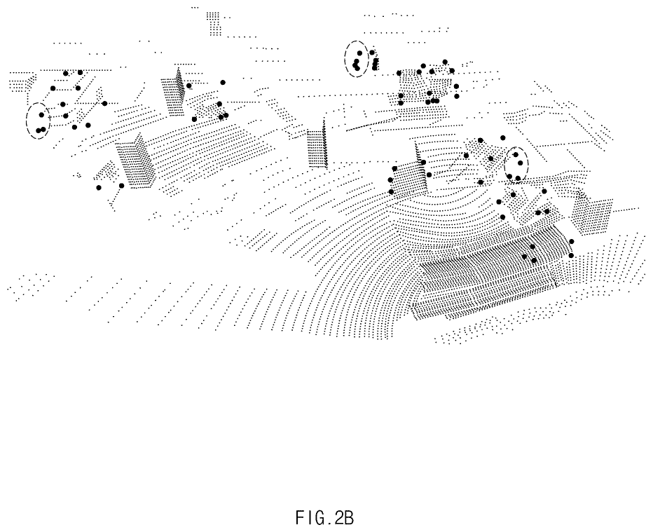

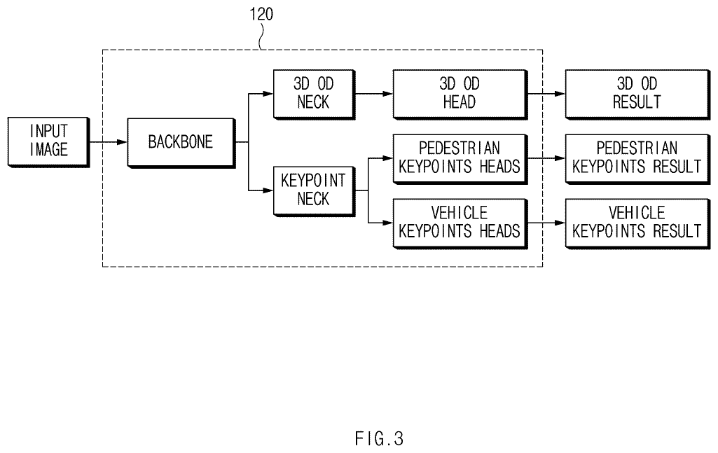

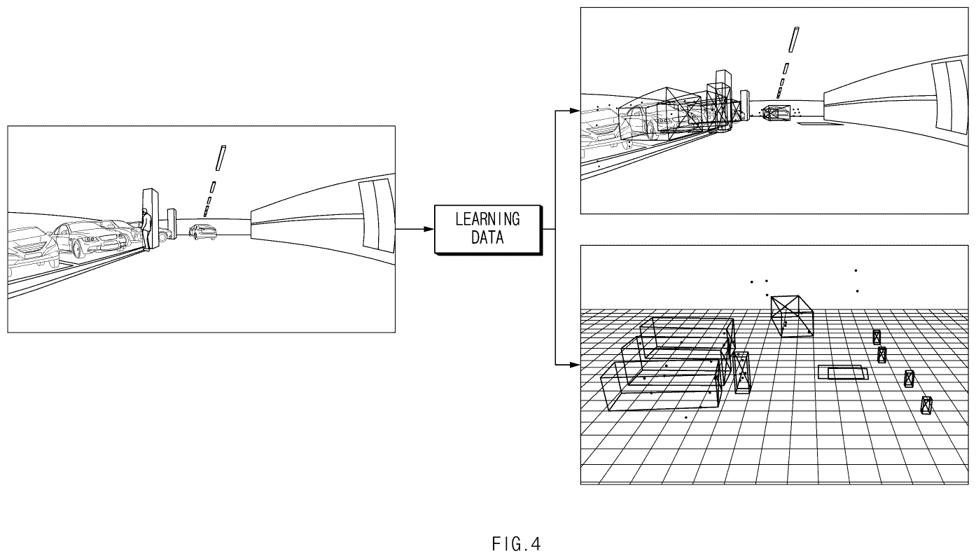

FIG. 1 is a view illustrating the configuration of an apparatus (hereinafter, a vehicle control apparatus) for controlling a vehicle, according to an embodiment of the present disclosure. FIGS. 2A and 2B are views illustrating an operation for generating 3D keypoint data by the vehicle control apparatus, according to an embodiment of the present disclosure. FIG. 3 is a view illustrating a control structure of a controller, according to an embodiment of the present disclosure. FIG. 4 is a view illustrating an operation for recognizing an object based on learning data of the vehicle control apparatus, according to an embodiment of the present disclosure.

According to an embodiment of the present disclosure, the vehicle control apparatus may be implemented in the vehicle. In this case, the vehicle control apparatus may be formed integrally with the internal control units of the vehicle or may be implemented separately from the internal control units of the vehicle and may be connected with the internal control units of the vehicle through a separate connector.

Referring to FIG. 1, according to an embodiment of the present disclosure, the vehicle control apparatus may include a sensor 110 and a controller 120.

The sensor 110 may include at least one sensor to obtain information about objects around the vehicle to generate 3D data about the objects around the vehicle. The sensor 110 may include a camera 111. For example, the camera 111 may be a surrounded view monitoring (SVM) camera, but the present disclosure is not limited thereto. The SVM camera may include a front view camera, a rear view camera, a left view camera, and a right view camera. Each camera may be tuned to be applied to the SVM system to capture the optimal SVM image.

In addition, the sensor 110 may further include a light and ranging (Lidar) device (sometimes referred to herein as simply “Lidar”) 115 (sometimes referred to herein as simply “Lidar”). The Lidar 115 may measure the difference between a time at which a laser beam in a pulse state is irradiated to an object and a time at which the laser beam is reflected and returned from the object, to measure the distance to the object, the position of the object, and the shape of the object in 3D. The measurement data of the Lidar 115 point data. A bounding box (BBox), e.g., in a rectangular shape, corresponding to the object, may be generated based on the point data. Then, a track including a position estimation value of the object may be generated based on the bounding box to maintain the generated track, thereby tracking the object.

Additionally, or alternatively, the sensor 110 may include sensors to obtain information about objects positioned around the vehicle in other schemes.

The controller 120 may be connected to each component of the vehicle control apparatus to perform the overall function of the vehicle control apparatus. The control device 120 may be a hardware device, such as a processor or a central processing unit (CPU), or a program implemented by a processor.

The controller 120 may obtain a 3D bounding box for each object based on the data obtained from the camera 111 and the Lidar 115. The controller 120 may generate information about the 3D keypoint for the object to estimate a 3D position, a 3D shape, and a 3D posture of the object, and may recognize the object based on the estimation result.

In an embodiment, the controller 120 obtains the 3D bounding box (BBox) for the objects, and learns an operation for generating information (3D keypoint information) about the 3D keypoint, thereby exactly estimating the 3D position, 3D shape, and the 3D posture for each object using the learned data.

Accordingly, the controller 120 includes a feature extracting device 130, a 3D information generating device 140, and an object recognizing device 150.

In an embodiment, when receiving the point data obtained from the camera 111 and the point data obtained from the Lidar 115, the feature extracting device 130 combines the input image data and the input point data to extract feature information for each object. The feature extracting device 130 may extract information about the 3D bounding box (BBox) and information about the 2D keypoint, that correspond to each object positioned in a relevant space, based on the extracted feature information. For example, the feature extracting device 130 may extract the information about the 3D bounding box and the information about the 2D keypoint through a labeling technology generally utilized in a feature extracting scheme.

The 3D bounding box may be formed in a box shape that surrounds objects, such that the objects are contained within the 3D bounding box. The 2D keypoint may be provided in the form of a cluster including a plurality of keypoints.

The 3D information generating device 140 may match a bounding box with a keypoint cluster corresponding to each object based on the information about the 3D bounding box and the information about the 2D keypoint extracted by the feature extracting device 130. The 3D information generating device 140 may match the bounding box with the keypoint cluster, through an Intersection over Union (IOU). The IOU is a criterion used to evaluate the accuracy of an object detecting algorithm. The criterion may be found by measuring the overlap between the predicted bounding box and the ground truth. For example, the criterion may be found by using a proportion of the overlap between two the predicted bounding box and the ground truth, based on the whole region.

The 3D information generating device 140 may select Lidar points, among Lidar points obtained from the Lidar 115, that are positioned inside each bounding box. The 3D information generating device 140 may project the selected Lidar points onto an image obtained from the camera 111. Projection of selected Lidar points onto an image, according to an embodiment, is described in more detail below with reference to FIG. 2A.

In an embodiment, the 3D information generating device 140 may calculate a weight by using information about the selected Lidar points and information about keypoints matched with the relevant bounding box. The 3D information generating device 140 may apply the calculated weight to the depth (Lidar point depth) of the Lidar points to calculate the depth (keypoint depth) of the keypoints.

The depth of the keypoints may be calculated using following Equation 1.

$${d}_{k} = \sum {w}_{i k} {d}_{i l} \qquad Equation 1$$

In Equation 1, dₖ denotes a keypoint depth, wᵢₖ denotes a keypoint weight, and di denotes the depth of the Lidar point.

The wᵢₖ, which is a keypoint weight, may be calculated using the distance between the Lidar point and the keypoint matched to the relevant bounding box. The keypoint weight may be calculated using Equation 2 below.

$${w}_{i k} = \frac{exp ( - dist ( {P}_{kpt} , {P}_{l}^{i} ) )}{\sum exp ( - dist ( {P}_{kpt} , {P}_{l} ) )} \qquad Equation 2$$

In Equation 2, wᵢₖ denotes a keypoint weight, Pₖₚₜ denotes keypoint coordinates, Pi denotes projected Lidar point coordinates, and dist( ) denotes an Euclidean distance between two points. The Euclidean distance between two points is a length of a line segment linking two points to each other in Euclidean space. The Euclidean space may be understood as a plane in a 2D space. Accordingly, the difference in coordinate value between two points in each axial direction may be found over a Cartesian coordinate system. The Pythagorean theorem may then be applied to the difference, thereby finding the Euclidean distance.

In Equation 2, the keypoint weight may be calculated using an exponential function having the Euclidean distance between the keypoint coordinates Pₖₚₜ and the projected Lidar point coordinates, Pₗ, as an exponent.

The 3D information generating device 140 may calculate the reliability for the depth of the keypoint, that is calculated in the above description, based on the distribution state of the Lidar points surrounding the keypoint.

The reliability for the depth of the keypoint may be calculated using Equation 3 below.

$${r}_{kpt} = mean ( {( \frac{dist ( {P}_{kpt} , {p}_{il} ) - mean ( dist ( {p}_{kpt} , {p}_{l} ) )}{std ( dis t ( {p}_{kpt} , {p}_{l} ) )} )}^{4} ) \qquad Equation 3$$

In Equation 3, rₖₚₜ denotes the reliability of a keypoint depth, dist (pₖₚₜ, pᵢₗ) denotes the Euclidean distance between pₖₚₜ and pᵢₗ, mean (dist (pₖₚₜ, pᵢₗ)) denotes the average value of the Euclidean distance between pₖₚₜ and pᵢₗ, and std(dist (pₖₚₜ, pᵢₗ)) denotes the standard deviation of the Euclidean distance between Pₖₚₜ and pᵢₗ.

In this case, the reliability for the keypoint depth may have a greater value as compared to Lidar points, as a larger number of Lidar points are clustered around the relevant keypoint.

The 3D information generating device 140 may generate pseudo keypoint coordinates based on keypoint coordinates and the keypoint depth value calculated using Equation 1, and may project the pseudo keypoint coordinates onto a Lidar space. The Lidar space onto which the pseudo keypoint coordinates are projected, according to an embodiment, is described in more detail below with reference to FIG. 2B.

In an embodiment, the 3D information generating device 140 projects pseudo keypoint coordinates onto the Lidar space, as illustrated in FIG. 2B, and allows keypoint coordinates to be laterally symmetrical to each other about the center of the bounding box of the relevant object, when viewed in a cross-sectional view. When a keypoint is present at a relevant position in the Lidar space, the 3D information generating device 140 may compare the two keypoints with each other in reliability and may select a keypoint having higher reliability.

The 3D information generating device 140 may not allow the relevant keypoint to be laterally symmetrical to each other. For example, when the pseudo keypoint coordinates projected onto the Lidar space have the reliability of a specific value or less, the 3D information generating device 140 may not allow the relevant keypoint to be laterally symmetrical.

The 3D information generating device 140 may remove, from the Lidar space, keypoint coordinates that are outside of the bounding box of the object, from among keypoint coordinates projected onto the Lidar space. The 3D information generating device 140 may correct the reliability of the relevant keypoint coordinates to zero.

The 3D information generating device 140 may generate the depth ‘d’ which is the 3D information, and the reliability ‘r’ for the depth, with respect to 2D keypoint coordinates (u, v), thereby estimating information (u, v, d, r) for the keypoint coordinates. Accordingly, the 3D information generating device 140 may estimate even the coordinates of the keypoint that is hidden.

The object recognizing device 150 may recognize objects based on information about the 3D keypoint generated by the 3D information generating device 140.

According to an embodiment, the controller 120 has a control structure as illustrated in FIG. 3.

Referring to FIG. 3, the controller 120 may include a control structure including a backbone, a neck, and a head.

The backbone serves to extract multi-scale features from the input image.

The neck serves to combine multi-scale features extracted from the backbone for each task. The neck may be classified onto a 3D object detection (OD) neck and a keypoint neck for each task. Multi-scale features extracted from the backbone may be input onto the 3D OD neck and the keypoint neck, respectively.

The 3D OD neck generates the features (e.g., the information about the 3D bounding box) of an object by combining multi-scale features. In addition, the keypoint neck generates 3D keypoint information such as keypoint features, (for example, keypoint coordinates, and a keypoint depth), by combining the multi-scale features. For example, the keypoint neck may generate a keypoint feature for a pedestrian to output and output the keypoint feature to pedestrian keypoints heads. As another example, the keypoint neck may generate a keypoint feature for a vehicle and output the keypoint feature to vehicle keypoints heads.

The head may output the result of the operation of each tack. The head may include a 3D OD head, pedestrian keypoints heads, and vehicle keypoints heads.

The 3D OD head may generate and output a 3D object detection result based on the features of the 3D object input from the 3D OD neck. For an operation of generating and outputting the 3D object detection result in a 3D OD head, a scheme generally used to detect characteristic information of an object may be applied.

Pedestrian keypoints heads may generate and output final keypoint information of pedestrians based on the 3D keypoint features for pedestrians.

Vehicle keypoints heads may generate and output final keypoint information of the vehicle based on the 3D keypoint features for vehicles.

In this case, keypoints heads, such as Pedestrian keypoints heads and vehicle keypoints heads may be classified onto an offset vector head among 2D keypoint heatmap heads, a heatmap and actual coordinates, and depth heads of the relevant keypoint. Accordingly, the keypoints heads may generate the final keypoint information about the object, by using the offset vector among the 2D keypoint heatmap, a heatmap, and actual coordinates, and the depth of each keypoint.

Referring again to FIG. 1, the controller 120 may further include a learning device 160. According to an embodiment, the learning device 160 may be provided as a component separate from the controller 120.

The learning device 160 may learn operations of the feature extracting device 130 and the 3D information generating device 140 while performing the operation for recognizing an object from the sensor data input from the camera 111 and the Lidar 115. For example, the learning device 160 may learn the operation for generating the 3D bounding box information and 3D keypoint information, based on the image of the camera 111 and the point data of the Lidar 115.

The learning device 160 may calculate the loss of the depth of the relevant keypoint when learning the 3D keypoint information. The learning device 160 may reflect the calculated result when estimating the 3D keypoint based on the learning data.

In an embodiment, the loss (1) of the 3D keypoint depth may be calculated using Equation 4 below.

$$l = {r}_{k p t} \vert {d}_{k p t} - \vert \qquad Equation 4$$

In Equation 4, ‘I’ denotes the loss of the depth of the 3D keypoint, rₖₚₜ denotes the reliability for the depth of the 3D keypoint, and dₖₚₜ denotes the depth of the 3D keypoint.

According to Equation 4, the learning device 160 may utilize, as a weight, the information about the reliability rₖₚₜ calculated through Equation 3 in the process of generating the 3D keypoint information.

In an embodiment, the learning device 160 may learn the relevant keypoint only when the reliability rₖₚₜ for the depth of the 3D keypoint exceeds a preset reference value, for example, 0.5. The learning device 160 may not learn the relevant keypoint when the reliability rₖₚₜ for the depth of the 3D keypoint does not exceed a preset reference value, and may correct the reliability for the relevant keypoint to ‘O’.

As described above, the learning device 160 may perform learning only for the 3D keypoint having the higher reliability, thereby improving the reliability for the learning data.

The learning device 160 may perform learning based on a deep learning network. In an embodiment, the deep learning network may simultaneously learn 3D object information (that is, 3D bounding box information and 3D keypoint information).

In this case, when a real vehicle performs self-driving, the deep-learning network, which is trained, may provide learning data generated as the learning result, to the autonomous driving system.

The deep-learning network may provide learning data to the vehicle system performing an object recognition operation, as well as the autonomous driving system.

Accordingly, the object recognizing device 150 may generate the information about the 3D bounding box and the information about the 3D keypoint for the input image, based on the learning data of the deep-learning network. The object recognizing device 150 may thus recognize the object to exactly estimate the 3D position, the 3D shape, and the 3D posture of the vehicle and the pedestrian, thereby improving the accuracy of the recognition for the object.

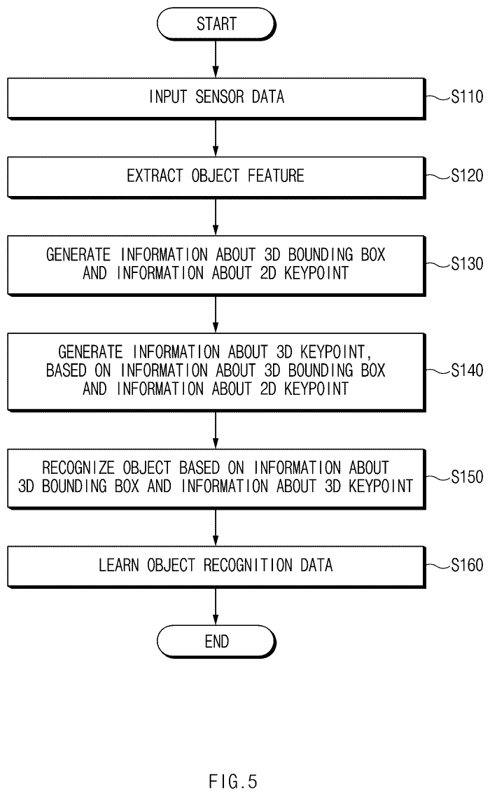

The operation flow of the vehicle control system, according to an embodiment, is described in more detail below with reference to FIGS. 5-7.

FIGS. 5-7 are flowcharts illustrating a method for controlling a vehicle, according to an embodiment of the present disclosure.

Referring to FIG. 5, when receiving sensor data from sensors, such as the camera 111 and the Lidar 115 in an operation S110, the vehicle control apparatus extracts features of an object based on sensor data input in the process S110 in an operation S120.

In an operation S130, the vehicle control apparatus generates the information about the 3D bounding box and the information about the 2D keypoint based on the features of the object extracted in the operation S120. In an operation S140, the vehicle control apparatus generates the information about the 3D keypoint, based on the information about the 3D bounding box and the information about the 2D keypoint.

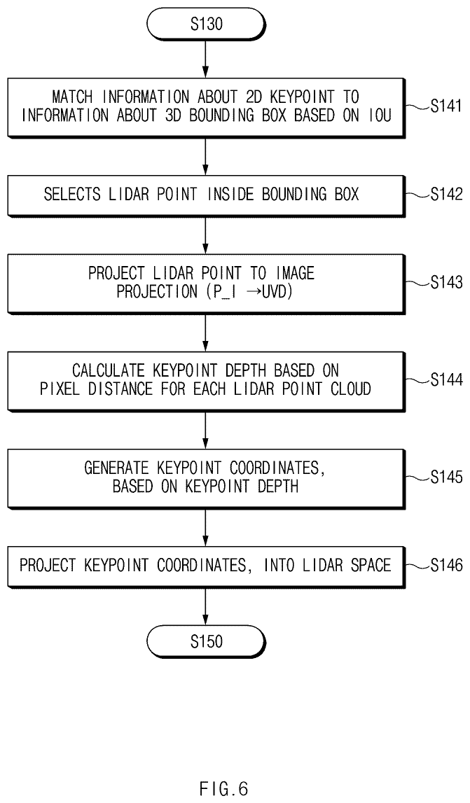

The operation S140, according to an embodiment, should be more clearly understood from the description below with reference to FIG. 6.

Referring to FIG. 6, in an operation S141, the vehicle control apparatus may match information about the 2D keypoint to the information about the 3D bounding box based on the IOU.

In an operation S142, the vehicle control apparatus selects a Lidar point positioned inside the bounding box for each object, which is selected from the sensor data of the Lidar 115. In an operation S143 the vehicle control apparatus projects the Lidar point selected in the operation S142 to an image. The operation of projecting the Lidar point, according to an embodiment, is described in more detail below with reference to FIG. 2A.

In an operation S144, the vehicle control apparatus calculates a keypoint depth based on a pixel distance for each Lidar point cloud projected to the image. In an operation S145, the vehicle control apparatus generates 3D keypoint coordinates, based on the keypoint depth calculated in the operation S144.

In an operation S146, the vehicle control apparatus projects 3D keypoint coordinates, that are generated in the operation S145, onto the Lidar space. The operation of projecting the Lidar point, according to an embodiment, is described in more detail below with reference to FIG. 2A.

Referring again to FIG. 5, in an operation S150, the vehicle control apparatus recognizes an object based on the information about the 3D bounding box generated in S130 and the information about the 3D keypoint information generated in S140.

In an operation S160, the vehicle control apparatus may learn the operation for generating the information about the 3D bounding box and the information about the 3D keypoint for each object from the sensor data based on the operations S110-S150.

The vehicle control apparatus may perform the object recognition operation based on learning data learned in the operation S160. The object recognition operation, according to an embodiment, is described in more detail below with reference to FIG. 2A.

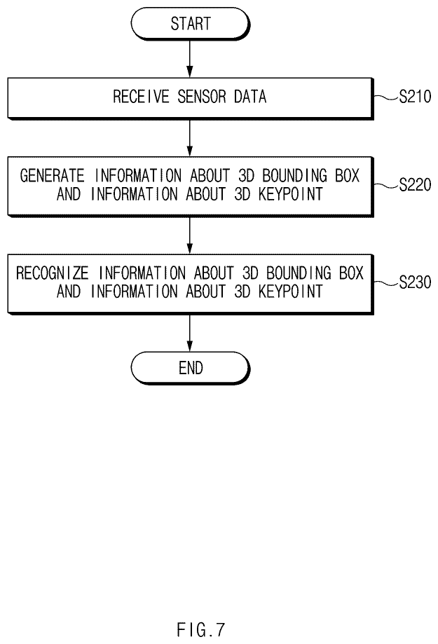

Referring to FIG. 7, the vehicle control apparatus generates the information about the 3D bounding box and the information about the 3D keypoint for each object, which are included in the sensor data, based on the learning data in an operation S220, when receiving the sensor data from the sensors such as the camera 111 and the Lidar 115 in an operation S210.

In an operation S230, the vehicle control apparatus recognizes an object based on the information about the 3D bounding box and the information about the 3D keypoint information which are generated in the operation S220.

In the operation S230, the vehicle control apparatus may estimate and recognize the position, the shape, and the posture of a target vehicle and/or a target pedestrian, by using the information about the 3D bounding box and the information about the 3D keypoint for the pedestrian as well as the vehicle.

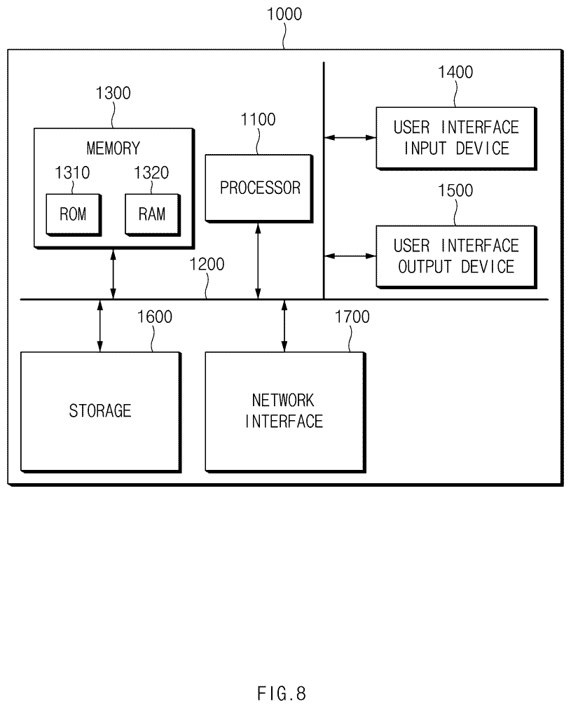

FIG. 8 illustrates a computing system, according to an embodiment of the present disclosure.

Referring to FIG. 8, a computing system 1000 may include at least one processor 1100, a memory 1300, a user interface input device 1400, a user interface output device 1500, a storage 1600, and a network interface 1700. The memory 1300, the user interface input device 1400, the user interface output device 1500, th storage 1600, and the network interface 1700 may be connected with each other via a bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only memory (ROM) and a random access memory (RAM).

Thus, the operations of the methods or algorithms described in connection with the embodiments disclosed in the present disclosure may be directly implemented with a hardware module, a software module, or the combinations thereof, executed by the processor 1100. The software module may reside on a storage medium (e.g., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as separate components of the user terminal.

As described above, according to an embodiment of the present disclosure, in the apparatus and method for controlling the vehicle, information about the 3D keypoint may be generated in the 3D space, based on information about a 3D bounding box corresponding to an object and information about a 2D keypoint corresponding to the object. Thus, the position and the motion of the object may be easily detected based on the information about the 3D keypoint. In addition, the depth and a hidden point of a 3D keypoint are estimated when the information about the 3D keypoint of the object is generated. Thus, the information about the object may be precisely detected, and the object recognition rate may be increased. In addition, the pose and/or the intent of the pedestrian may be easily detected based on the information about the 3D keypoint.

According to an embodiment of the present disclosure, the information about the 3D keypoint in the 3D space may be generated, based on the information about the 3D bounding box corresponding to the object and the information about the 2D keypoint corresponding to the object, such that the pose and the motion of the object are easily detected, based on the information about the 3D keypoint.

According to an embodiment of the present disclosure, the depth and the hidden point of the 3D keypoint may be estimated when the information about the 3D keypoint of the object is generated. Thus, the information about the object may be precisely detected, and the object recognition rate may be increased, allowing the information about the object to be utilized in autonomous driving.

In addition, according to an embodiment of the present disclosure, the pose and/or the intent of the pedestrian may be easily detected based on the information about the 3D keypoint obtained with respect to the pedestrian.

The above description is merely illustrative of the technical idea of the present disclosure. Various modifications and modifications may be made by one having ordinary skill in the art without departing from the essential characteristic of the present disclosure.

Therefore, embodiments of the present disclosure are provided to explain the spirit and scope of the present disclosure, but not to limit them. The spirit and scope of the present disclosure is not limited by the embodiments. The scope of protection of the present disclosure should be construed by the attached claims, and all equivalents thereof should be construed as being included within the scope of the present disclosure.

Hereinabove, although the present disclosure has been described with reference to example embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. An apparatus for controlling a vehicle, the apparatus comprising:
a camera configured to obtain a surrounding image of the vehicle;
a Lidar configured to obtain point cloud data detected from one or more objects positioned around the vehicle; and
a controller configured to
generate information about a three dimensional (3D) bounding box and information about a two dimensional (2D) keypoint, corresponding to each object among the one or more objects, based on sensor data obtained from the camera and the Lidar,
estimate a depth of each keypoint based on the information about the 3D bounding box and the information about the 2D keypoint to generate information about a 3D keypoint for each object among the one or more objects, and
recognize each object among the one or more objects based on the information about the 3D bounding box and the information about the 3D keypoint.

2. The apparatus of claim 1, wherein the controller is further configured to:
when generating the information about the 3D keypoint for each object among the one or more objects, match a bounding box for the object with a keypoint cluster,
select Lidar points, among Lidar points obtained from the Lidar, that are positioned inside the bounding box, and
project the selected Lidar points onto an image obtained from the camera.

3. The apparatus of claim 2, wherein the controller is further configured to:
when generating the information about the 3D keypoint for each object among the one or more objects, calculate a keypoint weight using the selected Lidar points and information about keypoints matched to the bounding box; and
calculate depths of the keypoints by applying the keypoint weight to depths of the Lidar points.

4. The apparatus of claim 3, wherein the keypoint weight is calculated by using an exponential function having distances between the Lidar points and the keypoints matched with the bounding box, as exponents.

5. The apparatus of claim 3, wherein the controller is configured to:
when generating the information about the 3D keypoint for each object among the one or more objects, calculate reliability for the depths of a keypoint based on a distribution state of the Lidar points for a surrounding region of the keypoint.

6. The apparatus of claim 5, wherein the controller is configured to:
when generating the information about the 3D keypoint for each object among the one or more objects, calculate the reliability for the depths of the keypoints by using distances between the Lidar points and the keypoints matched with the bounding box and a mean value and a standard deviation of the distances.

7. The apparatus of claim 5, wherein a reliability for the depths of the keypoints has a greater value as compared to the Lidar points.

8. The apparatus of claim 5, wherein the controller is further configured to:
when generating the information about the 3D keypoint for each object among the one or more objects, generate pseudo keypoint coordinates based on coordinates and depth values of the keypoints, and
project the generated pseudo keypoint coordinates onto a Lidar space.

9. The apparatus of claim 8, wherein the controller is further configured to:
allow the pseudo keypoint coordinates, that are projected onto the Lidar space, to be bilaterally symmetrical to each other about a center of the bounding box of each object among the one or more objects, in a cross-sectional view; and
prevent keypoint coordinates, among the pseudo keypoint coordinates that are projected onto the Lidar space, that are equal to or less than a reference value in the reliability for the depths of the keypoints, from being bilaterally symmetrical to each other.

10. The apparatus of claim 8, wherein the controller is configured to:
when i) the pseudo keypoint coordinates are projected onto the Lidar space and ii) keypoint coordinates are present at a relevant position in the Lidar space,
compare reliability between the depths of the keypoint and the pseudo keypoint, and
select a keypoint having higher reliability.

11. The apparatus of claim 8, wherein the controller is further configured to:
remove, from the Lidar space, keypoint coordinates, among the keypoint coordinates projected onto the Lidar space, that are outside of the bounding box for each object among the one or more objects, and
correct reliability of the keypoint coordinates to zero if the pseudo keypoint coordinates are projected onto the Lidar space.

12. The apparatus of claim 1, wherein the controller is further configured to:
learn an operation for generating the information about the 3D bounding box corresponding to the one or more objects and the information about the 3D keypoint corresponding to the one or more objects, based on the sensor data obtained from the camera and the Lidar; and
output learning data generated as a learning result.

13. The apparatus of claim 12, wherein the controller is configured to:
learn information about the 3D keypoint if reliability for a depth of the 3D keypoint exceeds a reference value.

14. The apparatus of claim 12, wherein the controller is configured to:
when learning the information about the 3D keypoint, calculate loss of the depth of the 3D keypoint by employing a reliability for the depth of the 3D keypoint as a weight, and
when estimating the 3D keypoint based on learning data, reflect the loss of the depth of the 3D keypoint.

15. A method for controlling vehicle, the method comprising:
generating information about a 3D bounding box and information about a 2D keypoint, corresponding to each object among one or more objects positioned around the vehicle, based on sensor data obtained from a camera and a Lidar;
estimating a depth of keypoints of each object among the one or more objects, based on the information about the 3D bounding box and the information about the information about the 2D keypoint to generate information about a 3D keypoint for each object among the one or more objects; and
recognizing each object, among the one or more objects, based on the information about the 3D bounding box and the information about the 3D keypoint.

16. The method of claim 15, wherein generating the information about the 3D keypoint for each object among the one or more objects includes:
matching a bounding box for the object with a keypoint cluster;
selecting Lidar points, among Lidar points obtained from the Lidar, that are positioned inside each bounding box;
projecting the selected Lidar points onto an image obtained from the camera;
calculating a keypoint weight using the selected Lidar points and information about keypoints matched to the bounding box;
calculating depths of the keypoints by applying the keypoint weight to depths of the Lidar points;
calculating reliability for the depths of the keypoints based on a distribution state of the Lidar points for a surrounding region of the keypoint;
generating pseudo keypoint coordinates based on coordinates and depth values of the keypoints; and
projecting the generated pseudo keypoint coordinates onto a Lidar space.

17. The method of claim 16, wherein generating the information about the 3D keypoint for each object among the one or more objects includes:
allowing pseudo keypoint coordinates, that are projected onto the Lidar space, to be bilaterally symmetrical to each other about a center of the bounding box of each object among the one or more objects, in a cross-sectional view; and
preventing keypoint coordinates, among the pseudo keypoint coordinates that are projected onto the Lidar space, that are equal to or less than a reference value in the reliability for the depths of the keypoints, from being bilaterally symmetrical to each other.

18. The method of claim 16, wherein generating the information about the 3D keypoint for each object among the one or more objects includes:
when i) the pseudo keypoint coordinates are projected onto the Lidar space and ii) keypoint coordinates are present at a relevant position in the Lidar space
comparing reliability between the depths of the keypoint and the pseudo keypoint, and
selecting a keypoint having higher reliability.

19. The method of claim 16, wherein generating the information about the 3D keypoint for each object among the one or more objects includes:
removing, from the Lidar space, keypoint coordinates, among keypoint coordinates projected onto the Lidar space, that are out of the bounding box of the object; and
correcting reliability for relevant keypoint coordinates to zero when the pseudo keypoint coordinates are projected onto the Lidar space.

20. The method of claim 15, further comprising:
learning an operation for generating the information about the 3D bounding box corresponding to the one or more objects and the information about the 3D keypoint corresponding to the one or more objects, based on the sensor data obtained from the camera and the Lidar; and
outputting learning data generated as a learning result.
